(19) United States
(12) Patent Application Publication
(10) Pub. No.: US 2023/0039132 A1
(43) Pub. Date: Feb. 9, 2023

(54) CONTROLLER FOR VEHICLE, AND CHARGING SYSTEM

(71) Applicant: TOYOTA JIDOSHA KABUSHIKI KAISHA, Toyota-shi (JP)

(72) Inventors: Toshiya HASHIMOTO, Miyoshi-shi (JP); Kazuhisa MATSUDA, Sunto-gun (JP); Fumihiko NAKAMURA, Susono-shi (JP); Manabu HANDA, Susono-shi (JP); Hiroya CHIBA, Fuji-shi (JP)

(73) Assignee: TOYOTA JIDOSHA KABUSHIKI KAISHA, Toyota-shi (JP)

(21) Appl. No.: 17/815,255

(22) Filed: Jul. 27, 2022

(30) Foreign Application Priority Data
Aug. 3, 2021 (JP) 2021-127445

(51) Int. Cl. B60L 53/66; B60L 53/12; B60L 58/12; H02J 7/00; H02J 50/00; G06Q 50/06

(52) U.S. Cl. CPC B60L 53/665; B60L 53/12; B60L 58/12; H02J 7/0071; H02J 7/00712; H02J 50/00; G06Q 50/06

(57) ABSTRACT

A server includes a communication device and a processor. The communication device obtains a power rate unit price dependent on a region where external charging is performed and a time slot when external charging is performed. The processor calculates a first power rate indicating a power rate when the external charging is performed with a first power feeding facility provided at a departure place before departure of a vehicle, calculates a second power rate indicating a power rate when the external charging is performed with a second power feeding facility provided in the vicinity of a traveling route after departure of the vehicle, and when the second power rate is lower than the first power rate, reduces an amount of power feeding during the external charging with the first power feeding facility, as compared with when the second power rate is equal to or higher than the first power rate.

This nonprovisional application is based on Japanese Patent Application No. 2021-127445 filed on Aug. 3, 2021 with the Japan Patent Office, the entire contents of which are hereby incorporated by reference.

### BACKGROUND

### Field

The present disclosure relates to a controller for a vehicle, and a charging system.

### Description of the Background Art

Japanese Patent Laying-Open No 2013-200247 discloses a navigation device mounted on a vehicle. The vehicle is capable of performing external charging to charge a power storage device mounted on the vehicle with a power feeding facility provided outside the vehicle. The navigation device includes a route searching unit, a cost calculating unit and a comparing unit. The route searching unit searches for a plurality of routes of the vehicle from a current location to a destination of the vehicle, with a charging facility being used in each route. The cost calculating unit calculates a cost for each searched route. The comparing unit compares the cost for each route and determines which route is suitable based on a result of comparison.

### SUMMARY

Using a power feeding facility provided in the vicinity of a traveling route from a departure place to a destination of a vehicle, external charging may be performed after departure of the vehicle. Using a power feeding facility provided at the departure place of the vehicle (such as home), the external charging may also be performed before departure of the vehicle. When the external charging is performed before and after departure of the vehicle as described above, it is preferable to reduce a total of a power rate when the external charging is performed before departure of the vehicle and a power rate when the external charging is performed after departure of the vehicle. Japanese Patent Laying-Open No. 2013-200247 does not discuss such a reduction in total power rate.

The present disclosure has been made to solve the above-described problem, and an object of the present disclosure is to provide a controller for a vehicle, and a charging system, which can achieve a reduction in total power rate when external charging is performed before and after departure of the vehicle.

A controller for a vehicle according to an aspect of the present disclosure is a controller for a vehicle, the vehicle being capable of performing external charging to charge a power storage device mounted on the vehicle with a power feeding facility provided outside the vehicle. The controller includes: an obtaining device; and a processor. The obtaining device obtains a power rate unit price, the power rate unit price being dependent on a region where the external charging is performed and a time slot when the external charging is performed. The processor calculates a power rate when the external charging is performed, in accordance with an amount of power feeding to the power storage device by the external charging, the region where the external charging is performed and the time slot when the external charging is performed, and the power rate unit price obtained by the obtaining device. Under a condition that a traveling route from a departure place to a destination of the vehicle and a scheduled departure time of the vehicle are set, the processor calculates a first power rate, the first power rate indicating a power rate when the external charging is performed with a first power feeding facility provided at the departure place before departure of the vehicle, calculates a second power rate, the second power rate indicating a power rate when the external charging is performed with a second power feeding facility provided in the vicinity of the traveling route after departure of the vehicle, and when the second power rate is lower than the first power rate, reduces the amount of power feeding during the external charging with the first power feeding facility, as compared with when the second power rate is equal to or higher than the first power rate.

With the above-described configuration, when the second power rate is lower than the first power rate, the external charging with the second power feeding facility instead of the first power feeding facility can reduce the power rate, as to an amount of electric power corresponding to an amount of reduction in the amount of power feeding to the power storage device during the external charging with the first power feeding facility. As a result, a total power rate when the external charging is performed with the first power feeding facility and the second power feeding facility can be made lower than a power rate when the external charging is performed only with the first power feeding facility.

The vehicle may include a power reception device that wirelessly receives electric power from a power transmission device while the vehicle is traveling on a traveling lane, the power transmission device being placed at the traveling lane and serving as the second power feeding facility. The vehicle may perform the external charging such that the electric power received by the power reception device is stored in the power storage device. The processor may calculate the second power rate as a power rate when the external charging is performed while the vehicle is traveling on the traveling lane.

With the above-described configuration, the external charging of the vehicle is performed without a user getting out of the vehicle. Therefore, it is possible to reduce the total power rate when the external charging is performed, while reducing the time required for arrival of the vehicle at the destination.

The processor may estimate an amount of charge power charged into the power storage device from the power transmission device through the power reception device, in accordance with a power transmission efficiency from the power transmission device to the power reception device, and determine an amount of reduction in the amount of power feeding during the external charging with the first power feeding facility such that the amount of reduction is smaller as the estimated amount of charge power is smaller.

As the power transmission efficiency is lower, the amount of charge power is smaller. Therefore, when the power transmission efficiency is low, the amount of reduction in the amount of power feeding during the external charging at the departure place may not be complemented by the transmission power from the power transmission device, even if the vehicle travels on the traveling lane. As a result, it may be assumed that, due to the reduction in the amount of power feeding to the power storage device at the departure place, exhaustion of the amount of power storage in the power storage device occurs before the vehicle arrives at the destination. However, according to the above-described configuration, the amount of reduction in the amount of power feeding during the external charging at the departure place is determined to appropriately reflect the power transmission efficiency while the vehicle is traveling on the traveling lane. Therefore, even when the power transmission efficiency is low, exhaustion of the amount of power storage in the power storage device before the vehicle arrives at the destination can be avoided.

A controller for a vehicle according to another aspect of the present disclosure is a controller for a vehicle, the vehicle being capable of performing external charging to charge a power storage device mounted on the vehicle with a power feeding facility provided outside the vehicle. The controller includes; an obtaining device; and a processor. The obtaining device obtains a power rate unit price, the power rate unit price being dependent on a region where the external charging is performed and a time slot when the external charging is performed. Under a condition that a traveling route from a departure place to a destination of the vehicle and a scheduled departure time of the vehicle are set, the processor obtains a first power rate unit price through the obtaining device, the first power rate unit price indicating a power rate unit price when the external charging is performed with a first power feeding facility provided at the departure place before departure of the vehicle, obtains a second power rate unit price through the obtaining device, the second power rate unit price indicating a power rate unit price when the external charging is performed with a second power feeding facility provided in the vicinity of the traveling route after departure of the vehicle, and when the second power rate unit price is lower than the first power rate unit price, reduces an amount of power feeding to the power storage device during the external charging with the first power feeding facility, as compared with when the second power rate unit price is equal to or higher than the first power rate unit price.

A power rate when the external charging is performed is calculated in accordance with the amount of power feeding from the power feeding facility to the power storage device and the power rate unit price, and as the power rate unit price is lower, the power rate when the external charging is performed is lower. With the above-described configuration, when the second power rate unit price is lower than the first power rate unit price, the external charging with the second power feeding facility instead of the first power feeding facility can reduce the power rate, as to an amount of electric power corresponding to an amount of reduction in the amount of power feeding to the power storage device during the external charging with the first power feeding facility. As a result, a total power rate when the external charging is performed with the first power feeding facility and the second power feeding facility can be made lower than a power rate when the external charging is performed only with the first power feeding facility.

The processor may set a charging schedule such that the first power rate unit price is lower when timer charging is performed in a time slot set in accordance with the charging schedule than when the timer charging is not performed, the timer charging being the external charging with the first power feeding facility.

As the first power rate unit price is lower, the first power rate is lower. With the above-described configuration, the first power rate when the timer charging is performed with the first power feeding facility can be reduced. As a result, the total of the first power rate and the second power rate can be reduced.

The processor may perform a process for inquiring of a user of the vehicle about whether or not to reduce the amount of power feeding.

From the perspective of user convenience, it may be preferable to inquire the user about whether or not to reduce the amount of power feeding during the external charging with the first power feeding facility. With the above-described configuration, the user convenience can be improved.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows an overall configuration of a charging process system including a server serving as a controller for a vehicle according to the present embodiment.

FIG. 2 shows configurations of a vehicle, a wireless power feeding facility, a power feeding stand, and a user terminal.

FIG. 3 shows, in detail, configurations of an ECU and its related devices of the vehicle, and the server.

FIG. 4 shows an example of a data table indicating main information extracted from a power feeding facility information database and a unit price information database.

FIG. 5 shows a traveling route of the vehicle in the present embodiment.

FIG. 6 is a diagram for illustrating an amount of power feeding to a power storage device during external charging only with a power feeding stand at a departure place.

FIG. 7 is a diagram for illustrating a process for reducing the amount of power feeding to the power storage device during the external charging with the power feeding stand at the departure place.

FIG. 8 is a flowchart showing an example of a process performed in connection with the external charging of the vehicle in the present embodiment.

FIG. 9 shows an example of a screen displayed on a display device of an HMI device when a second power rate is lower than a first power rate.

FIG. 10 is a flowchart showing an example of a process performed in connection with external charging of a vehicle in a second modification.

FIG. 11 is a flowchart showing the example of the process performed in connection with the external charging of the vehicle in the second modification.

FIG. 12 shows an example of a time slot when external charging is performed in each of a comparative example and a third modification.

FIG. 13 is a flowchart showing an example of a process performed in connection with the external charging of a vehicle in the third modification.

FIG. 14 is a flowchart showing the example of the process performed in connection with the external charging of the vehicle in the third modification.

FIG. 15 shows a traveling route of a vehicle in a fifth modification.

### DESCRIPTION OF THE PREFERRED EMBODIMENTS

An embodiment of the present disclosure will be described in detail hereinafter with reference to the drawings, in which the same or corresponding portions are denoted by the same reference characters and description thereof will not be repeated.

### EMBODIMENT

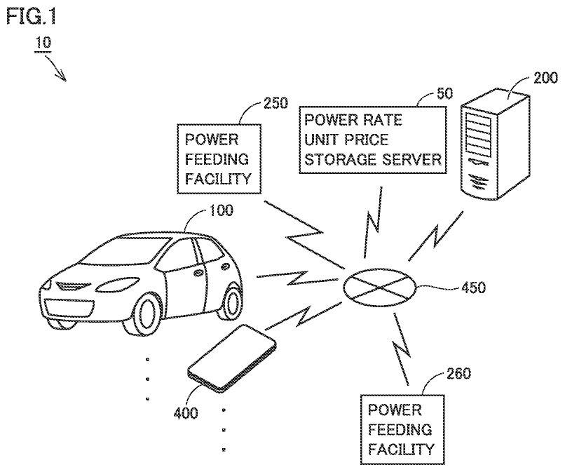

FIG. 1 schematically shows an overall configuration of a charging process system including a server serving as a controller for a vehicle according to the present embodiment.

A charging process system 10 includes a power rate unit price storage server 50, a vehicle 100, a server 200, power feeding facilities 250 and 260, and a user terminal 400. Power rate unit price storage server 50, vehicle 100, server 200, power feeding facilities 250 and 260, and user terminal 400 are connected to a communication network 450 such as the Internet.

Power rate unit price storage server 50 stores a power rate unit price that is dependent on a region and a time slot. The power rate unit price is updated sequentially.

Vehicle 100 is an electrically powered vehicle on which a power storage device for traveling is mounted, and is, for example, a battery electric vehicle (BEV). Vehicle 100 is capable of performing external charging to charge the power storage device mounted on vehicle 100 with power feeding facilities 250 and 260 provided outside vehicle 100.

Power feeding facility 250 (first power feeding facility) is provided at a departure place of vehicle 100. Power feeding facility 260 (second power feeding facility) is provided in the vicinity of a traveling route to a destination of vehicle 100. “The vicinity” of the traveling route refers to an area that is within a prescribed distance from the traveling route, and includes the traveling route itself.

Server 200 communicates with vehicle 100 through communication network 450. Server 200 obtains, through communication network 450, the power rate unit price stored in power rate unit price storage server 50. Server 200 calculates a power rate when the external charging of vehicle 100 is performed, in accordance with the above-described power rate unit price.

Server 200 sets a power feeding plan (charging plan) to the vehicle-mounted power storage device by the external charging with power feeding facility 250 and power feeding facility 260. The power feeding plan refers to a plan about an amount of power feeding to the power storage device by the external charging with power feeding facility 250 and power feeding facility 260, and a plan including a start time and an end time (charging schedule) of the external charging. For example, server 200 changes a charging threshold value (described in detail below) of the external charging with power feeding facility 250, and transmits the changed charging threshold value to vehicle 100 through communication network 450. Thus, the amount of power feeding from power feeding facility 250 to the power storage device is adjusted. The external charging will be described in detail below.

User terminal 400 is a mobile terminal operated by a user of vehicle 100, and is, for example, a smartphone, a tablet terminal or a wearable terminal. By operating user terminal 400, the user can input the destination and a scheduled departure time of vehicle 100.

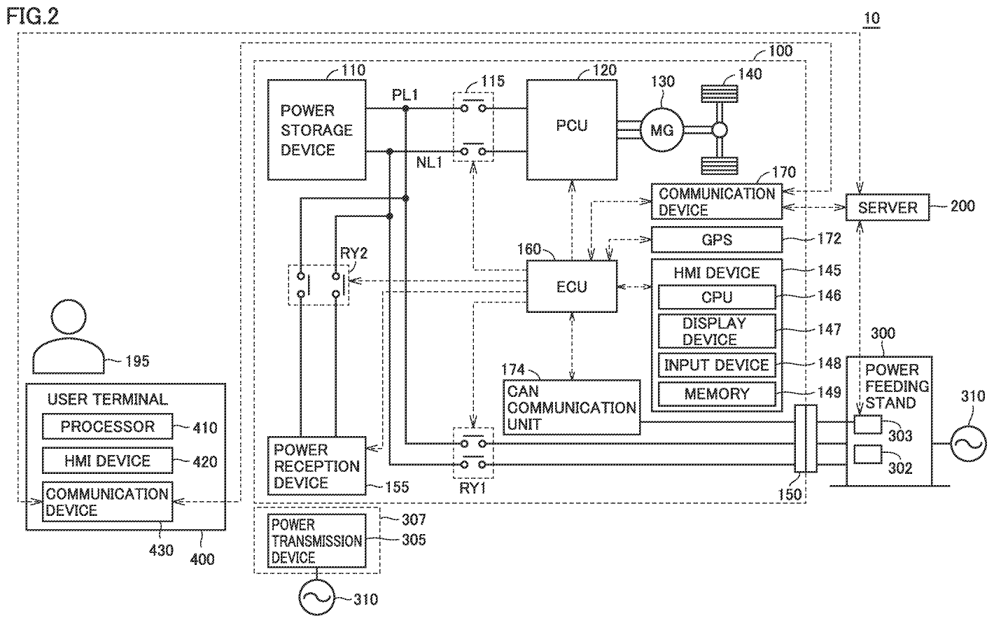

FIG. 2 shows configurations of vehicle 100, a wireless power feeding facility 307, a power feeding stand 300, and user terminal 400. Wireless power feeding facility 307 is an example of power feeding facility 260 (FIG. 1) provided in the vicinity of the traveling route to the destination of vehicle 100. Power feeding stand 300 is an example of power feeding facility 250 (FIG. 1) provided at the departure place of vehicle 100.

Referring to FIG. 2, vehicle 100 includes a power storage device 110, a system main relay (SMR) 115, a power control unit (PCU) 120, a motor generator (MG) 130, and a driving wheel 140. Vehicle 100 further includes charging relays RY1 and RY2, an inlet 150, a power reception device 155, and a human machine interface (HMI) device 145. Vehicle 100 further includes an electronic control unit (ECU) 160, a communication device 170, a global positioning system (GPS) receiver 172, and a controller area network (CAN) communication unit 174.

Power storage device 110 is a power storage element that stores electric power for traveling. Power storage device 110 includes, for example, a secondary battery such as a lithium ion battery or a nickel metal hydride battery, and a power storage element such as an electric double layer capacitor. The lithium ion secondary battery is a secondary battery including lithium as a charge carrier, and may include not only a general lithium ion secondary battery containing a liquid electrolyte but also an all-solid-state battery containing a solid electrolyte. An amount of power storage in power storage device 110 is indicated by, for example, a state of charge (SOC). Power storage device 110 is provided with a voltage sensor, a current sensor and a temperature sensor that detect a voltage, a current and a temperature thereof, respectively (all are not shown). The detection values by these sensors are output to ECU 160.

SMR 115 is provided between power lines PL1 and NL1 connected to power storage device 110 and PCU 120. SMR 115 is controlled into an ON state while vehicle 100 is traveling.

PCU 120 includes power converters such as a converter and an inverter. PCU 120 converts DC power received from power storage device 110 into AC power. PCU 120 converts AC power generated by MG 130 (described below) into DC power.

MG 130 is typically an AC rotating electric machine, and is, for example, a three-phase AC synchronous motor including a rotor into which a permanent magnet is embedded. MG 130 is driven by PCU 120 to generate the rotational driving force. The driving force generated by MG 130 is transmitted to driving wheel 140. Thus, vehicle 100 travels. During regenerative braking of vehicle 100, MG 130 can generate electric power by using the rotational force of driving wheel 140 (regenerative power generation). The electric power generated by the regenerative power generation is charged into power storage device 110 through PCU 120.

Charging relay RY1 is connected to power lines PL1 and NL1. Charging relay RY1 is controlled into an ON state when the external charging is performed with power feeding stand 300. Charging relay RY1 is controlled into an OFF state when the external charging is performed with wireless power feeding facility 307. Details of power feeding stand 300 and wireless power feeding facility 307 will be described below.

Inlet 150 receives electric power supplied from a system power supply 310 such as a commercial power supply through power feeding stand 300 during the external charging. The electric power is supplied to power storage device 110 through charging relay RY1. Hereinafter, the external charging performed using the electric power supplied from power feeding stand 300 to inlet 150 will also be referred to as “wired charging”.

Communication device 170 allows bidirectional data communication between vehicle 100 and server 200 and between vehicle 100 and user terminal 400 through communication network 450 such as the Internet (FIG. 1). In addition, communication device 170 allows short-range communication with wireless power feeding facility 307 provided outside vehicle 100.

Power reception device 155 includes a power reception coil and a power converter (both are not shown). The power reception coil wirelessly receives AC power from system power supply 310 through a power transmission device 305 of wireless power feeding facility 307. The power converter converts the AC power wirelessly received by the power reception coil into DC power having a voltage level of power storage device 110. The converted power is charged into power storage device 110.

Wireless power feeding facility 307 includes power transmission device 305. Power transmission device 305 wirelessly transmits electric power to power reception device 155. Power transmission device 305 includes a power transmission coil (not shown). When an AC current is supplied to the power transmission coil, an electromagnetic field is formed around the power transmission coil. The power reception coil in power reception device 155 of vehicle 100 wirelessly receives the electric power through the electromagnetic field. As described above, the electric power is supplied from power transmission device 305 to power reception device 155. The electric power supplied from power transmission device 305 to power reception device 155 is charged into power storage device 110 through charging relay RY2. Hereinafter, the external charging performed using the electric power supplied from power transmission device 305 to power reception device 155 will also be referred to as “wireless charging”.

Charging relay RY2 is provided between power storage device 110 and power reception device 155. Charging relay RY2 is controlled into an ON state while the wireless charging is being performed. In contrast, charging relay RY2 is controlled into an OFF state while the wireless charging is not performed (e.g., while the wired charging is being performed).

HMI device 145 is a terminal device that provides various types of information to a user 195 of vehicle 100 or receives an input operation by user 195. HMI device 145 includes a display device 147, an input device 148, a memory 149, and a central processing unit (CPU) 146. HMI device 145 may further include a microphone and a speaker (both are not shown) for voice recognition function. Display device 147 displays various types of information to user 195 of vehicle 100.

Input device 148 receives an input of an operation by user 195. Input device 148 receives, for example, a user operation for setting a destination and a scheduled departure time of vehicle 100, and a user operation for providing an instruction to perform timer charging (described below) and setting a charging completion time. Input device 148 may be a hardware keyboard, or may be a software keyboard.

Memory 149 stores programs and data for causing HMI device 145 to perform various functions CPU 146 performs the programs and data stored in memory 149. Thus, HMI device 145 can function as, for example, a car navigation device.

As an example, when user 195 sets the destination and the scheduled departure time of vehicle 100 using input device 148, the information indicating the destination and the scheduled departure time is transmitted from HMI device 145 to ECU 160. Thereafter, the information is transmitted to server 200 through communication device 170. Then, a traveling route from the current location to the destination of vehicle 100 and a scheduled arrival time of vehicle 100 at the destination are set by server 200. The set traveling route is transmitted from server 200 to vehicle 100, and then, is displayed by display device 147. The traveling route of vehicle 100 may be set by ECU 160, instead of server 200.

GPS receiver 172 identifies a position of the current location (departure place) of vehicle 100 based on a radio wave from an artificial satellite. The position information identified by GPS receiver 172 is used by HMI device 145 serving as a car navigation device, and ECU 160. In the present embodiment, the position information identified by GPS receiver 172 is transmitted to ECU 160, and then, is transmitted to server 200 through communication device 170.

CAN communication unit 174 performs CAN communication between vehicle 100 and power feeding stand 300 during the external charging. The communication between vehicle 100 and power feeding stand 300 is not limited to the CAN communication, and may be power line communication (PLC), wireless communication or the like. For example, when a connector of power feeding stand 300 is connected to inlet 150, a sensing signal indicating that the connector of power feeding stand 300 has been connected to inlet 150 is input to CAN communication unit 174.

ECU 160 controls the devices of vehicle 100 in accordance with each sensor signal, and a program, data and a map stored in a memory. As an example, ECU 160 controls SMR 115, PCU 120, charging relays RY1 and RY2. HMI device 145, power reception device 155, communication device 170, CAN communication unit 174 and the like.

ECU 160 calculates the SOC of power storage device 110 in accordance with the voltage, the current and the temperature of power storage device 110. A known method such as a method using an OCV-SOC curve (such as a map) indicating a relationship between an open circuit voltage (OCV) and the SOC is used as a method for calculating the SOC.

ECU 160 performs the external charging to charge power storage device 110 with the power feeding facility. This external charging may be any of wired charging or wireless charging.

For example, ECU 160 turns on charging relay RY1 at the time of the wired charging of vehicle 100. Then, ECU 160 transmits a charging start request to power feeding stand 300 through CAN communication unit 174. Thus, the wired charging is performed. When the SOC of power storage device 110 reaches the charging threshold value (e.g., SOC when power storage device 110 is in a fully-charged state), ECU 160 transmits a charging stop request to power feeding stand 300 through CAN communication unit 174. Thus, the wired charging ends.

In contrast, ECU 160 turns on charging relay RY2 at the time of the wireless charging of vehicle 100. Then, ECU 160 transmits the charging start request to wireless power feeding facility 307 through communication device 170. Thus, the wireless charging is started. A detailed configuration of ECU 160 will be described below.

Power feeding stand 300 includes a power feeding device 302 and a communication device 303. At the time of the external charging, power feeding device 302 converts the AC power from system power supply 310 into DC power and supplies the converted power to inlet 150 through the connector (not shown) of power feeding stand 300. Power feeding device 302 may output the AC power from system power supply 310 to inlet 150. In this case, a power converter (charging device) is provided between charging relay RY1 and inlet 150. The power converter converts the AC power from power feeding device 302 into DC power having a voltage level of power storage device 110.

Communication device 303 allows bidirectional communication with CAN communication unit 174 and server 200. The information exchanged between communication device 303 and CAN communication unit 174 includes, for example, the charging start request and the charging stop request for the external charging.

User terminal 400 includes a processor 410, an HMI device 420 and a communication device 430. HMI device 420 can function as a car navigation device, similarly to HMI device 145. HMI device 420 includes a display device and an input device (both are not shown), similarly to HMI device 145.

Communication device 430 is an interface for wireless communication with vehicle 100 and server 200.

Processor 410 has a CPU and a memory built thereinto (both are not shown) Processor 410 performs various processes by controlling the devices (HMI device 420 and communication device 430) of user terminal 400 in accordance with information stored in the memory and information input to HMI device 420. For example, when user 195 sets the destination and the scheduled departure time of vehicle 100 using HMI device 420, the information indicating the setting results is transmitted from HMI device 420 to processor 410. Processor 410 transmits the information indicating the destination and the scheduled departure time to server 200 through communication device 430.

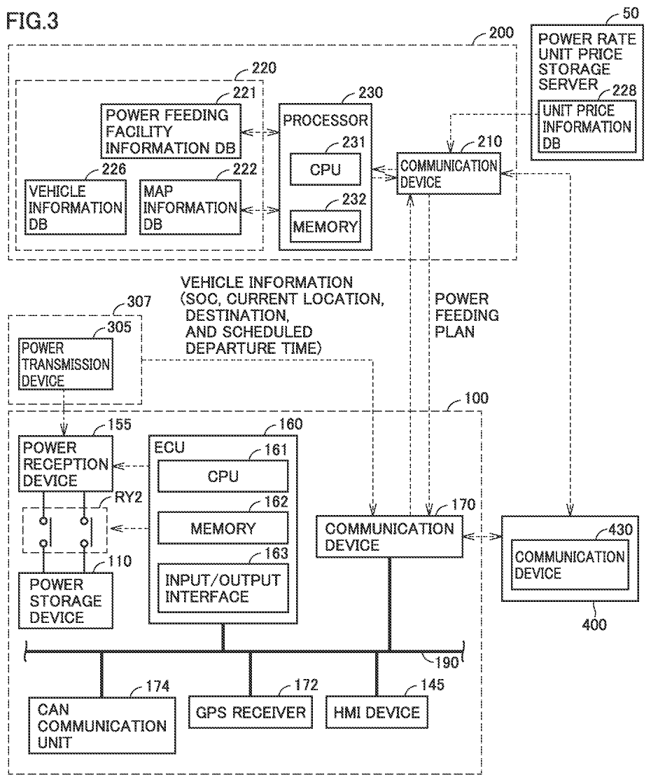

FIG. 3 shows, in detail, configurations of ECU 160 and its related devices of vehicle 100, and server 200. Referring to FIG. 3, ECU 160 includes a CPU 161, a memory 162 and an input/output interface 163. Memory 162 includes a read only memory (ROM) and a random access memory (RAM) (both are not shown). The ROM stores a program or the like performed by CPU 161. The RAM temporarily stores data or the like referenced by CPU 161.

ECU 160, communication device 170, GPS receiver 172, HMI device 145, and CAN communication unit 174 are connected to a vehicle-mounted network 190. ECU 160 can perform CAN communication with the devices through vehicle-mounted network 190.

When the connector of power feeding stand 300 is connected to inlet 150, ECU 160 exchanges various types of information (e.g., the charging start request and the charging stop request) with power feeding stand 300 through CAN communication unit 174, and performs the external charging. ECU 160 obtains, from GPS receiver 172, the position information indicating the position of the current location of vehicle 100. Furthermore, ECU 160 exchanges various types of information with server 200, user terminal 400 and wireless power feeding facility 307 through communication device 170. As an example, ECU 160 transmits vehicle information including various types of information about vehicle 100 to server 200 through communication device 170.

The vehicle information includes the current location of vehicle 100, the destination of vehicle 100, the scheduled departure time of vehicle 100, and the current SOC of power storage device 110. The destination and the scheduled departure time of vehicle 100 are set by user 195 using HMI device 145 or HIM device 420. The vehicle information may further include the presence or absence of the instruction to perform the timer charging (described below), and the timer charging completion time.

Server 200 may be a stationary device, or may be a portable, so-called mobile server. Server 200 includes a communication device 210, a storage device 220 and a processor 230.

Communication device 210 is communicable with vehicle 100, power rate unit price storage server 50 and user terminal 400. Communication device 210 obtains (receives) the above-described vehicle information from vehicle 100 by communication. Communication device 210 transmits, to vehicle 100, the power feeding plan to power storage device 110 by the external charging and the traveling route of vehicle 100, which are set by processor 230. Communication device 210 obtains information indicating a power rate unit price from a unit price information database (DB) 228 (described below) stored in power rate unit price storage server 50. Communication device 210 forms an example of “obtaining device” according to the present disclosure.

Storage device 220 includes a power feeding facility information database (DB) 221, a map information database (DB) 222 and a vehicle information database (DB) 226.

Power feeding facility information DB 221 stores information indicating specifications (e.g., transmission power) of the power feeding facility, a predicted value of a power transmission efficiency during the external charging, a length of a charging lane (described below) where power transmission device 305 serving as the power feeding facility is provided, and a position where the power feeding facility is placed. Map information DB 222 stores map information including road map data.

Vehicle information DB 226 stores an ID of vehicle 100, a charging type of the external charging that can be performed by vehicle 100, the SOC of power storage device 110, a vehicle type, and a ratio of travel distance of vehicle 100 relative to electric consumption in power storage device 110 that is predetermined as an average ratio of travel distance of vehicle 100 relative to electric consumption in power storage device 110, which depends on the vehicle type of vehicle 100. These databases are sequentially updated to a latest state by processor 230.

Processor 230 includes a CPU 231 and a memory 232. CPU 231 performs a program and data stored in memory 232. Memory 232 includes a ROM and a RAM (both are not shown). The ROM stores the program performed by CPU 231. The RAM temporarily stores the data referenced by CPU 231.

When the destination of vehicle 100 is set, processor 230 sets the traveling route from the current location to the destination of vehicle 100 based on the current location of vehicle 100, the destination of vehicle 100, and map information DB 222.

Power rate unit price storage server 50 includes unit price information DB 228. Unit price information DB 228 stores information indicating a power rate unit price (e.g., power rate unit price of system power supply 310) that varies depending on a region and a time slot. Unit price information DB 228 may be stored in storage device 220 of server 200.

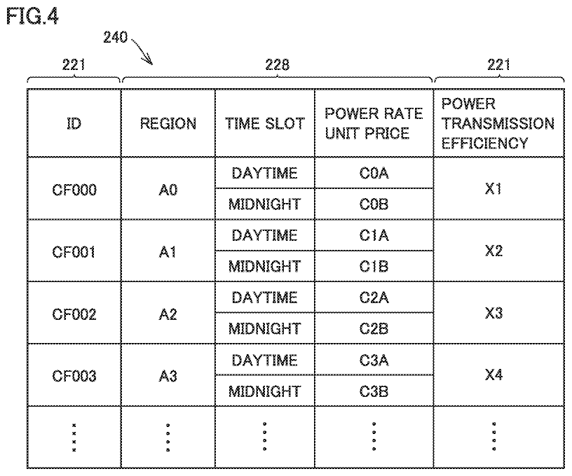

FIG. 4 shows an example of a data table indicating main information extracted from power feeding facility information DB 221 and unit price information DB 228. A data table 240 is generated by processor 230 (described in detail below) and stored in storage device 220.

Referring to FIG. 4, “ID” is extracted from power feeding facility information DB 221 by processor 230 and indicates identification information about the power feeding facility. “ID” is assigned to each power feeding facility registered in power feeding facility information DB 221. The power feeding facilities registered in power feeding facility information DB 221 include both a wired charging facility and a wireless charging facility. Although not shown, the ID of the power feeding facility is stored in association with position information indicating a position where the power feeding facility is provided.

“Region”, “time slot” and “power rate unit price” are extracted from unit price information DB 228 through communication device 210 by processor 230. “Power rate unit price” varies depending on “region”. For example, in a daytime time slot, a power rate unit price in a region A0 is C0A, while a power rate unit price in a region A1 is C1A. “Power rate unit price” varies depending on “time slot”. For example, in a region A2, when the time slot is a daytime time slot, a power rate unit price is C2A. In contrast, when the time slot is a midnight time slot, the power rate unit price is C2B. In this example, the power rate unit price in the midnight time slot is lower than the power rate unit price in the normal time slot (C2B<C2A). In this example, the twenty-four hours that form one day are divided into two time slots, i.e., the daytime time slot and the midnight time slot. However, this is merely one example. How to divide the twenty-four hours that form one day is predetermined as appropriate and is not limited.

“Power transmission efficiency” is extracted from power feeding facility information DB 221 by processor 230. “Power transmission efficiency” indicates a predicted value of a power transmission efficiency from power feeding device 302 of power feeding stand 300 to inlet 150 of vehicle 100 or a predicted value of a power transmission efficiency from power transmission device 305 of wireless power feeding facility 307 to power reception device 155 of vehicle 100. These predicted values are predetermined as appropriate by experiment and the like. For example, as to wireless charging, the power transmission efficiency refers to a ratio of the electric power received by power reception device 155 relative to the transmission power of power transmission device 305. The power transmission efficiency varies depending on a combination of a type of the power reception coil (shape of the coil, winding direction, shape of a magnetic core) that forms power reception device 155 and a type of the power transmission coil that forms power transmission device 305. Therefore, the predicted value of the power transmission efficiency of the wireless charging is predetermined as appropriate by experiment, for each combination of a type of power reception device 155 and a type of power transmission device 305.

The following is a description about how processor 230 generates data table 240. Processor 230 generates data table 240 by matching the position information associated with the ID of the power feeding facility registered in power feeding facility information DB 221 with the information indicating “region” registered in unit price information DB 228. Specifically, in accordance with map information DB 222, processor 230 determines which of a plurality of regions registered in unit price information DB 228 includes the position identified by the position information associated with the ID of the power feeding facility. Then, processor 230 associates the power rate unit price in the region including the position identified by the position information about the power feeding facility with the ID of the power feeding facility, and generates data table 240.

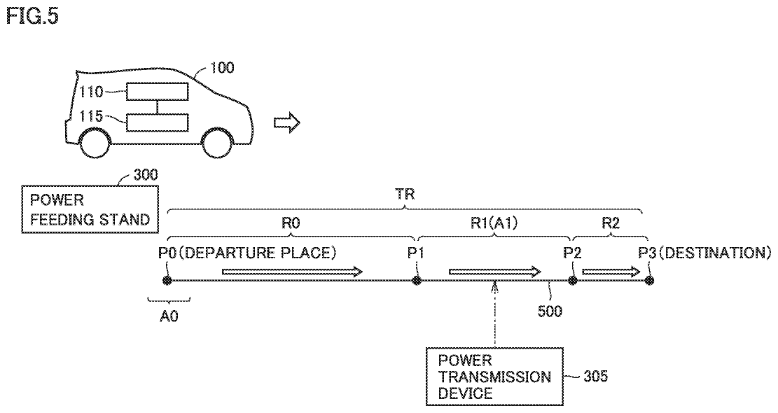

FIG. 5 shows the traveling route of vehicle 100 in the present embodiment. In the following description, reference is made to FIGS. 2 to 4 as appropriate.

A traveling route TR of vehicle 100 is set by processor 230 of server 200. Traveling route TR includes a route R0, a route R1 and a route R2.

Route R0 is a route of vehicle 100 from a departure place P0 to a point P1. Route R1 is a route of vehicle 100 from point P1 to a point P2. Route R2 is a route of vehicle 100 from point P2 to a destination P3.

In this example, power feeding stand 300 is provided at departure place P0 in region A0. Power feeding stand 300 corresponds to a power feeding facility having the ID of CF000 (FIG. 4).

A charging lane 500 is a traveling lane on which vehicle 100 travels to perform the wireless charging. Charging lane 500 is provided on route R1 in region A1. Power transmission device 305 provided at charging lane 500 corresponds to a power feeding facility having the ID of CF001 (FIG. 4). Although power transmission device 305 is provided below charging lane 500 in this example, power transmission device 305 may be provided on a side wall of charging lane 500.

While vehicle 100 is traveling on charging lane 500, power reception device 155 wirelessly receives electric power from power transmission device 305. During traveling, vehicle 100 performs the external charging such that the electric power received by power reception device 155 is stored in power storage device 110.

Using power transmission device 305 of charging lane 500 provided on traveling route TR from departure place P0 to destination P3 of vehicle 100, the external charging may be performed after departure of vehicle 100. Using power feeding stand 300 provided at departure place P0 of vehicle 100, the external charging may also be performed before departure of vehicle 100. When the external charging is performed before and after departure of vehicle 100 as described above, it is preferable to reduce a total of a power rate when the external charging is performed before departure of vehicle 100 and a power rate when the external charging is performed after departure of vehicle 100.

Server 200 in the present embodiment includes the following feature in order to reduce the above-described total power rate.

Specifically, communication device 210 obtains, from unit price information DB 228, a power rate unit price that is dependent on a region where the external charging is performed and a time slot when the external charging is performed. Processor 230 calculates a power rate when the external charging is performed, in accordance with an amount of power feeding to power storage device 110 by the external charging, the region where the external charging is performed and the time slot when the external charging is performed before and after departure of vehicle 100, and the power rate unit price obtained by communication device 210. Processor 230 performs this calculation process using data table 240 (FIG. 4). In this example, under a condition that traveling route TR from departure place P0 to destination P3 of vehicle 100 and the scheduled departure time of vehicle 100 are set, processor 230 calculates a first power rate and a second power rate.

The first power rate indicates a power rate when the external charging is performed with power feeding stand 300 provided at departure place P0 before departure of vehicle 100. The first power rate is calculated in accordance with a power rate unit price (first power rate unit price) when the external charging is performed with power feeding stand 300, and an amount of power feeding (first amount of power feeding) to power storage device 110 during the external charging with power feeding stand 300. Specifically, the first power rate corresponds to a multiplied value of the first power rate unit price and the first amount of power feeding. As described with reference to FIG. 4, the power rate unit price varies depending on the time slot and the region. Therefore, the first power rate unit price is dependent on region A0 where power feeding stand 300 is provided, and the time slot from the current time to the scheduled departure time of vehicle 100 (in the example of FIG. 4, whether the time slot when the external charging is performed is a daytime time slot or a midnight time slot), and the first power rate unit price is obtained by communication device 210.

The second power rate indicates a power rate when the external charging is performed with charging lane 500 provided on traveling route TR of vehicle 100 after departure of vehicle 100 (more specifically, after the scheduled departure time). The second power rate is calculated in accordance with a power rate unit price (second power rate unit price) when the external charging is performed with charging lane 500, and an amount of power feeding (second amount of power feeding) to power storage device 110 during the external charging with charging lane 500. Specifically, the second power rate corresponds to a multiplied value of the second power rate unit price and the second amount of power feeding.

The second power rate unit price is dependent on region A1 where charging lane 500 is provided, and the time slot including the time at which vehicle 100 is expected to be traveling on charging lane 500, and the second power rate unit price is obtained by communication device 210. This time slot is determined by processor 230 in accordance with a distance from departure place P0 to point P1, a distance from point P1 to point P2 (length of charging lane 500), an expected traveling speed of vehicle 100, and the scheduled departure time of vehicle 100. These distances are stored in map information DB 222 (FIG. 2). The expected traveling speed of vehicle 100 refers to, for example, an average speed of a legal upper limit speed and a legal lower limit speed of vehicle 100 on mutes R0 and R1.

The second amount of power feeding is estimated by processor 230 as an amount of electric power transmitted from power transmission device 305 to power reception device 155 while vehicle 100 is traveling on charging lane 500. The amount of electric power transmitted from power transmission device 305 to power reception device 155 is determined in accordance with a length of a time period in which power transmission device 305 transmits the electric power to power reception device 155, and the transmission power of power transmission device 305. This length of the time period is estimated by dividing the length of charging lane 500 by the expected traveling speed of vehicle 100 on route R2 (FIG. 5) where charging lane 500 is provided. Information indicating the length of charging lane 500 and the transmission power of power transmission device 305 at charging lane 500 is stored in power feeding facility information DB 221.

Processor 230 compares the second power rate with the first power rate, assuming that the first amount of power feeding is equal to the second amount of power feeding. Processor 230 performs a process for reducing the first amount of power feeding when the second power rate is lower than the first power rate, as compared with when the second power rate is equal to or higher than the first power rate. Specifically, processor 230 lowers a charging threshold value of the external charging at departure place P0, and transmits the lowered charging threshold value to vehicle 100. ECU 160 of vehicle 100 receives the above-described charging threshold value through communication device 170. Then, ECU 160 transmits the charging start request to power feeding stand 300. Thus, the external charging is performed, with the charging threshold value lowered. As a result, the amount of power feeding from power feeding stand 300 to power storage device 110 by the external charging is reduced.

The following is a description about a typical case in which the external charging is performed with power feeding stand 300 at departure place P0 (region A0) in the normal time slot when the power rate is not a midnight power rate, and then, vehicle 100 leaves departure place P0 and travels on charging lane 500 (region A1) in the midnight time slot.

In this case, the power rate unit price (second power rate unit price) when the external charging is performed with charging lane 500 is lower than the power rate unit price (first power rate unit price) when the external charging is performed with power feeding stand 300. Therefore, assuming that the first amount of power feeding is equal to the second amount of power feeding, the second power rate is lower than the first power rate. Therefore, the external charging with charging lane 500 instead of power feeding stand 300 can reduce the power rate, as to the amount of electric power supplied from power transmission device 305 at charging lane 500 through power reception device 155 to power storage device 110.

As a result, the total power rate when the external charging is performed with power feeding stand 300 and charging lane 500 can be made lower than the power rate when the external charging is performed only with power feeding stand 300.

“Total power rate” in the present embodiment also includes the second power rate itself when the external charging is performed only with charging lane 500, of power feeding stand 300 and charging lane 500. The following is a detailed description about the fact that the total power rate can be reduced in the present embodiment.

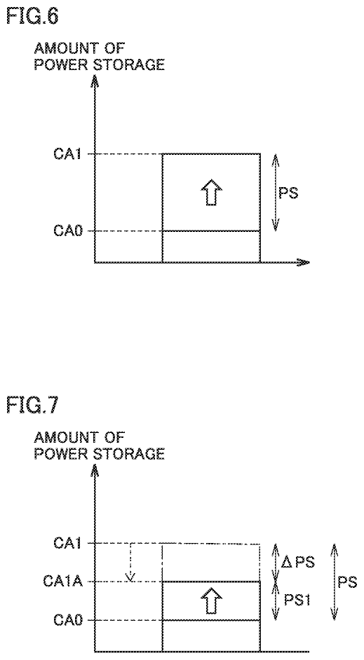

FIG. 6 is a diagram for illustrating the amount of power feeding to power storage device 110 during the external charging only with power feeding stand 300 at departure place P0. FIG. 6 is described as a comparative example when a below-described process is not performed by processor 230. Referring to FIG. 6, the vertical axis indicates an amount of power storage in power storage device 110.

An amount of power storage CA0 indicates an amount of power storage corresponding to the SOC of power storage device 110 before the start of the external charging with power feeding stand 300 (e.g., at the current time). In the comparative example, an amount of power storage CA1 indicates an amount of power storage corresponding to a target SOC of the external charging with power feeding stand 300. Amount of power storage CA1 refers to, for example, an amount of power storage when power storage device 110 is in a fully-charged state.

During a time period from the current time before departure of vehicle 100 to the scheduled departure time, the external charging is performed with power feeding stand 300. In the comparative example, during this time period, an amount of electric power corresponding to PS is supplied to power storage device 110. As a result, the amount of power storage in power storage device 110 increases from amount of power storage CA0 to amount of power storage CA1.

In this example, the first power rate is a multiplied value of the first power rate unit price and PS. The first power rate unit price is a unit price determined depending on the time slot in region A0 of departure place P0. In the comparative example, until vehicle 100 arrives at destination P3, the external charging is not performed at a place other than departure place P0. Therefore, the first power rate corresponds to a total power rate required for the external charging performed before vehicle 100 arrives at destination P3. This total power rate (first power rate) will also be referred to as “first total power rate” for the sake of convenience.

FIG. 7 is a diagram for illustrating the process for reducing the amount of power feeding to power storage device 110 during the external charging with power feeding stand 300 at departure place P0 Referring to FIG. 7, the vertical axis indicates the amount of power storage in power storage device 110, similarly to the comparative example.

An amount of power storage CA1A indicates an amount of power storage corresponding to the target SOC of the external charging with power feeding stand 300 in the present embodiment. Amount of power storage CA1A is smaller by ΔPS than amount of power storage CA1 corresponding to the target SOC in the comparative example. In this example, when the external charging is performed during the time period from the current time before departure of vehicle 100 to the scheduled departure time, the amount of power storage in power storage device 110 increases from amount of power storage CA0 to amount of power storage CA1A.

During this time period, an amount of electric power corresponding to PS1 is supplied to power storage device 110. PS1 is smaller by ΔPS than PS that is the amount of electric power supplied to power storage device 110 in the comparative example. In the present embodiment, the first power rate is a multiplied value of the first power rate unit price and PS1.

Vehicle 100 leaves departure place P0, and then, performs the external charging during a time period in which vehicle 100 is traveling on charging lane 500 (FIG. 5). During this time period, the electric power is supplied from power transmission device 305 through power reception device 155 to power storage device 110. As described above, the second power rate unit price is lower than the first power rate unit price. Therefore, from the perspective of a reduction in power rate, it is more preferable to perform the external charging with charging lane 500, than to perform the external charging with power feeding stand 300, as to the amount of electric power supplied from power transmission device 305 to power storage device 110.

Thus, processor 230 estimates the amount of power feeding from power transmission device 305 at charging lane 500 to power storage device 110, and reduces the amount of power feeding during the external charging at departure place P0 by an amount corresponding to the estimated value. Then, vehicle 100 performs the external charging at departure place P0, and then, travels on charging lane 500. Thus, even when the amount of power feeding to power storage device 110 at departure place P0 is reduced, the external charging is performed with charging lane 500 after departure of vehicle 100. As a result, the total power rate can be reduced without change of a total amount of power feeding to power storage device 110. The total amount of power feeding is a total of the amount of power feeding to power storage device 110 during the external charging at departure place P0 and the amount of power feeding from charging lane 500 to power storage device 110.

The following is a description about a method for determining the amount of reduction (ΔPS) in the amount of power feeding to power storage device 110 during the external charging at departure place P0. It is not preferable to determine ΔPS regardless of the estimated value of the amount of power feeding from charging lane 500 to power storage device 110. Specifically, even when vehicle 100 travels on charging lane 500, the amount of electric power corresponding to ΔPS may not be complemented, or a sufficient reduction in the total power rate may not be achieved.

In the present embodiment, processor 230 estimates the amount of power feeding from power transmission device 305 provided at charging lane 500 to power storage device 110, and determines ΔPS in accordance with the estimated value. In this example, processor 230 determines ΔPS such that the amount of power feeding from power transmission device 305 to power storage device 110 is equal to ΔPS. The second power rate in the present embodiment is a multiplied value of the second power rate unit price and ΔPS.

In the present embodiment, a total of the first power rate and the second power rate corresponds to a total power rate required for the external charging performed before vehicle 100 arrives at destination P3. This total power rate will also be referred to as “second total power rate” for the sake of convenience.

In comparison with the comparative example (FIG. 6), the second total power rate is lower than the first total power rate. The following is a description about this point.

As described above, in the present embodiment, the second power rate unit price is lower than the first power rate unit price. Therefore, the multiplied value of the second power rate unit price and ΔPS is smaller than the multiplied value of the first power rate unit price and ΔPS. Therefore, the power rate when the amount of electric power corresponding to ΔPS is supplied to power storage device 110 while vehicle 100 is traveling on charging lane 500 is lower than the power rate when the amount of electric power corresponding to ΔPS is supplied from power feeding stand 300 to power storage device 110 during the external charging in the comparative example. Thus, as to the amount of electric power corresponding to ΔPS, the power rate required for the external charging in the present embodiment is made lower than the power rate in the comparative example. As a result, the second total power rate in the present embodiment can be made lower than the first total power rate in the comparative example.

In comparison with the comparative example, a total amount of electric power supplied to power storage device 110 during the external charging performed after departure of vehicle 100 from departure place P0 before arrival at destination P3 is the same. Namely, even when the amount of power feeding at departure place P0 is reduced from PS to PS1, the amount of electric power corresponding to ΔPS is supplied to power storage device 110 at charging lane 500 before vehicle 100 arrives at destination P3. As a result, as long as vehicle 100 can arrive at destination P3, the reduction by ΔPS in the amount of power feeding to power storage device 110 at departure place P0 does not matter from the perspective of the amount of power storage in power storage device 110.

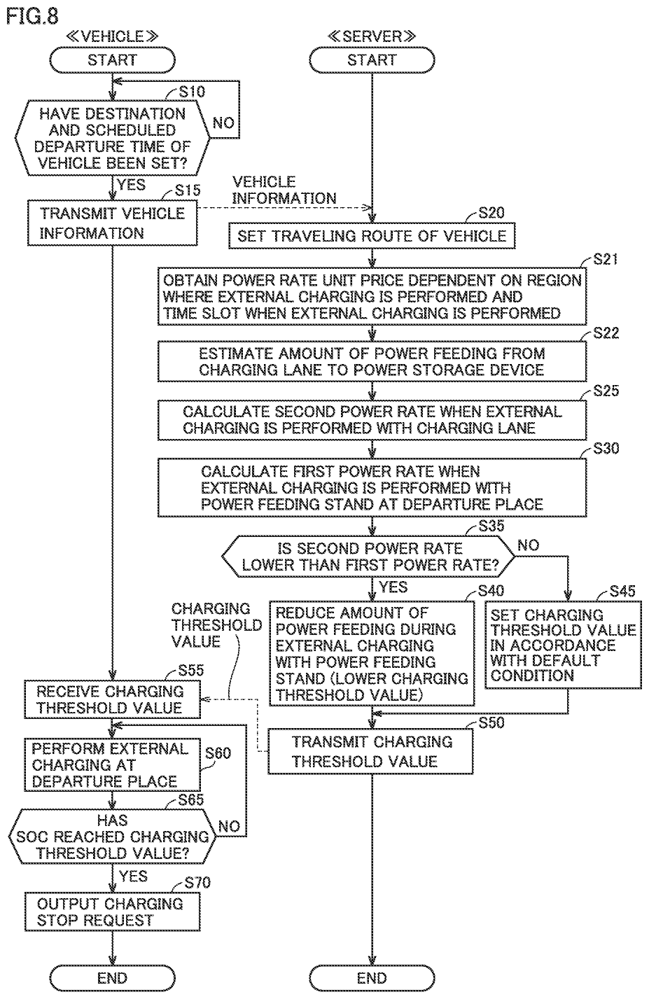

FIG. 8 is a flowchart showing an example of a process performed in connection with the external charging of vehicle 100 in the present embodiment. This flowchart is started when ECU 160 receives, through CAN communication unit 174, the sensing signal indicating that the connector of power feeding stand 300 has been connected to inlet 150 of vehicle 100. In the following description, reference is made to FIGS. 2 to 5 as appropriate.

Referring to FIG. 8, ECU 160 of vehicle 100 determines whether or not destination P3 and the scheduled departure time of vehicle 100 have been set (step S10). Specifically, ECU 160 determines whether or not ECU 160 has received, from HMI device 145 or HMI device 420, a signal indicating that user 195 has set destination P3 and the scheduled departure time of vehicle 100. When destination P3 and the scheduled departure time have not been set (NO in step S10), ECU 160 performs the above-described determination process until destination P3 and the scheduled departure time are set. When destination P3 and the scheduled departure time have been set (YES in step S10), ECU 160 transmits, to server 200, the vehicle information including the information indicating destination P3 and the scheduled departure time (step S15).

When processor 230 of server 200 receives the vehicle information through communication device 210, processor 230 of server 200 sets traveling route TR (FIG. 5) of vehicle 100 (step S20).

Communication device 210 obtains the power rate unit price that is dependent on the region where the external charging is performed and the time slot when the external charging is performed, in accordance with an instruction from processor 230 (step S21). Specifically, depending on time slot, communication device 210 obtains, from unit price information DB 228 (FIGS. 3 and 4), the first power rate unit price when the external charging is performed with power feeding stand 300 at departure place P0 in region A0 (FIG. 5). This time slot refers to a time slot from the current time to the scheduled departure time of vehicle 100. Depending on time slot, communication device 210 obtains, from unit price information DB 228, the second power rate unit price when the external charging is performed with charging lane 500 in region A1. This time slot refers to a time slot including the time at which vehicle 100 is expected to be traveling on charging lane 500.

Processor 230 estimates the amount of power feeding (second amount of power feeding) from charging lane 500 to power storage device 110 (step S22). Then, processor 230 calculates the second power rate when the external charging is performed with charging lane 500, in accordance with the second power rate unit price obtained by communication device 210 and the second amount of power feeding (step S25).

Processor 230 calculates the first power rate when the external charging is performed with power feeding stand 300 at departure place P0, in accordance with the first power rate unit price and the above-described first amount of power feeding (step S30). This first power rate is calculated, assuming that the first amount of power feeding is equal to the second amount of power feeding.

Processor 230 determines whether or not the second power rate is lower than the first power rate (step S35). When the second power rate is lower than the first power rate (YES in step S35), processor 230 performs the process for reducing, by ΔPS (FIG. 7), the amount of power feeding during the external charging with power feeding stand 300, as compared with when the second power rate is equal to or higher than the first power rate (step S40). Specifically, processor 230 lowers, by an amount corresponding to ΔPS, the charging threshold value of the external charging at departure place P0. In this case, the charging threshold value refers to a value of the SOC corresponding to CA1A (FIG. 7) that is smaller by ΔPS than amount of power storage CA1 (FIGS. 6 and 7).

In contrast, when the second power rate is equal to or higher than the first power rate (NO in step S35), processor 230 sets the charging threshold value of the external charging at departure place P0 in accordance with a default condition (step S45). In this case, the charging threshold value refers to a value of the SOC corresponding to CA1 (FIGS. 6 and 7).

After the processing of step S40 or S45, processor 230 transmits the charging threshold value to vehicle 100 (step S50).

ECU 160 of vehicle 100 receives the charging threshold value (step S55), and performs the external charging with power feeding stand 300 at departure place P0 in accordance with the charging threshold value (step S60).

Then, ECU 160 determines whether or not the SOC of power storage device 110 has reached the charging threshold value (step S65). When the SOC has not reached the charging threshold value (NO in step S65). ECU 160 performs the external charging at departure place P0 until the SOC reaches the charging threshold value. When the SOC has reached the charging threshold value (YES in step S65), ECU 160 outputs the charging stop request to power feeding stand 300 through CAN communication unit 174 (step S70). Thus, the external charging at departure place P0 ends.

The amount of power feeding to power storage device 110 during the external charging at departure place P0 varies depending on which processing of step S40 or step S45 has been performed. For example, when the processing of step S45 has been performed, the amount of electric power corresponding to PS (FIGS. 6 and 7) is supplied to power storage device 110 at departure place P0. In contrast, when the processing of step S40 has been performed, the amount of electric power corresponding to PS1 (=PS−ΔPS) (FIG. 7) is supplied to power storage device 110 at departure place P0. Then, vehicle 100 leaves departure place P0, and then, performs the external charging while traveling on charging lane 500. Thus, the amount of reduction (amount of electric power corresponding to ΔPS) in the amount of power feeding at departure place P0 is complemented. As a result, it is possible to reduce the total power rate while maintaining the total amount of electric power to power storage device 110.

As described above, server 200 according to the present embodiment includes communication device 210 and processor 230. Communication device 210 obtains the power rate unit price, the power rate unit price being dependent on the region where the external charging is performed and the time slot when the external charging is performed. Processor 230 calculates the power rate when the external charging is performed, in accordance with the amount of power feeding to power storage device 110 by the external charging, the region where the external charging is performed and the time slot when the external charging is performed, and the power rate unit price obtained by communication device 210. Under the condition that traveling route TR from departure place P0 to destination P3 of vehicle 100 and the scheduled departure time of vehicle 100 are set, processor 230 calculates the first power rate, the first power rate indicating the power rate when the external charging is performed with power feeding stand 300 provided at departure place P0 before departure of vehicle 100, and calculates the second power rate, the second power rate indicating the power rate when the external charging is performed with charging lane 500 provided in the vicinity of traveling route TR after departure of vehicle 100. When the second power rate is lower than the first power rate, processor 230 reduces the amount of power feeding during the external charging with power feeding stand 300, as compared with when the second power rate is equal to or higher than the first power rate.

Thus, when the second power rate is lower than the first power rate, the external charging with charging lane 500 instead of power feeding stand 300 can reduce the power rate, as to the amount of electric power corresponding to ΔPS. As a result, the total power rate when the external charging is performed with power feeding stand 300 and charging lane 500 can be made lower than the power rate when the external charging is performed only with power feeding stand 300 at departure place P0 Furthermore, processor 230 calculates the second power rate as the power rate when the external charging is performed while vehicle 100 is traveling on charging lane 500. Thus, the external charging of vehicle 100 is performed without user 195 getting out of vehicle 100. Therefore, it is possible to reduce the total power rate when the external charging is performed, while reducing the time required for arrival of vehicle 100 at the destination.

[First Modification]

In the above-described embodiment, processor 230 compares the first power rate with the second power rate, assuming that the first amount of power feeding is equal to the second amount of power feeding. Then, in accordance with the result of comparison between the second power rate and the first power rate, processor 230 determines whether or not to reduce, by ΔPS, the amount of power feeding to power storage device 110 at departure place P0.

When the external charging is performed, the power rate is calculated in accordance with the power rate unit price. Therefore, processor 230 comparing the first power rate with the second power rate as described above corresponds to processor 230 comparing the first power rate unit price obtained by communication device 210 with the second power rate unit price obtained by communication device 210.

In a first modification, when the second power rate unit price is lower than the first power rate unit price, processor 230 performs the process for reducing the amount of power feeding to power storage device 110 during the external charging with power feeding stand 300 at departure place P0, as compared with when the second power rate unit price is equal to or higher than the first power rate unit price.

Thus, the external charging with charging lane 500 can reduce the power rate, as to the amount of electric power (amount of electric power corresponding to ΔPS) corresponding to the amount of reduction in the amount of power feeding to power storage device 110 at departure place P0, as compared with when the external charging is performed with power feeding stand 300. As a result, the power rate (second total power rate) when the external charging is performed with power feeding stand 300 and charging lane 500 can be made lower than the power rate (first total power rate) when the external charging is performed only with power feeding stand 300. Namely, an advantage similar to that of the above-described embodiment can be produced.

[Second Modification]

From the perspective of convenience of user 195, it may be preferable to inquire user 195 about whether or not to reduce the amount of power feeding during the external charging with power feeding stand 300, when the second power rate is lower than the first power rate.

In a second modification, processor 230 performs a process for inquiring user 195 of vehicle 100 about whether or not to reduce the amount of power feeding during the external charging with power feeding stand 300 at departure place P0. Specifically, processor 230 outputs, to ECU 160, an instruction to cause display device 147 of HMI device 145 to display a screen for inquiring user 195 about whether or not to reduce the amount of power feeding.

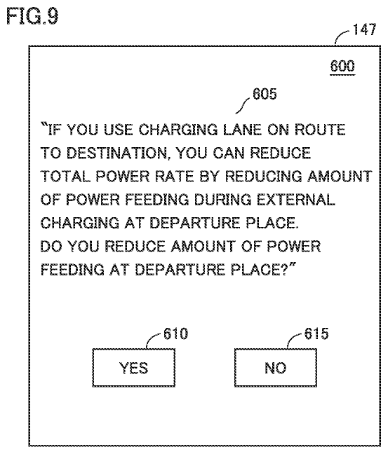

FIG. 9 shows an example of a screen displayed on display device 147 of HMI device 145 when the second power rate is lower than the first power rate.

Referring to FIG. 9, a screen 600 includes a message 605 and buttons 610 and 615. Message 605 indicates that the total power rate can be reduced if the amount of power feeding to power storage device 110 during the external charging at departure place P0 is reduced.

Buttons 610 and 615 correspond to input device 148 (FIG. 1). If user 195 operates button 610, a signal indicating the result of operation is transmitted to server 200 through communication device 170. When processor 230 of server 200 receives the signal, processor 230 of server 200 performs the process for reducing the amount of power feeding to power storage device 110 at departure place P0 from PS (FIG. 6) to PS1 (FIG. 7) that is smaller by ΔPS than PS. Specifically, processor 230 lowers the charging threshold value of the external charging at departure place P0 by a value of the SOC corresponding to ΔPS.

If user 195 operates button 615, a signal indicating the result of operation is transmitted to server 200 through communication device 170. When processor 230 of server 200 receives the signal, processor 230 of server 200 sets the charging threshold value in accordance with the default condition.

Even when the total power rate can be further reduced by vehicle 100 performing the external charging while traveling on charging lane 500, user 195 may desire not to reduce the amount of power feeding to power storage device 110 at departure place P0 (e.g., desire to fully charge power storage device 110). Therefore, whether or not user 195 desires to reduce the amount of power feeding to power storage device 110 at departure place P0 may vary depending on user 195.

Screen 600 displayed on display device 147 as described above makes it possible to inquire user 195 about whether or not to reduce the amount of power feeding. Therefore, the desire of user 195 that desires not to reduce the amount of power feeding to power storage device 110 at departure place P0 can be satisfied.

Processor 230 may output, to user terminal 400, an instruction to cause the display device of HMI device 420 of user terminal 400 to display screen 600. In this case, buttons 610 and 615 correspond to the input device of HMI device 420.

Alternatively, when HMI device 145 or HMI device 420 includes a microphone and a speaker, processor 230 may use the voice recognition function to inquire about whether or not to reduce the amount of power feeding to power storage device 110 at departure place P0. Specifically, processor 230 outputs an instruction to vehicle 100 or user terminal 400 through communication device 210 such that inquiry voice is output from the microphone of HMI device 145 or HMI device 420. Thus, the inquiry voice is output from the microphone. The user responds to the inquiry voice by voice (utterance). ECU 160 of vehicle 100 or processor 410 of user terminal 400 recognizes the voice and transmits a response result to server 200 through communication device 170 or communication device 430.

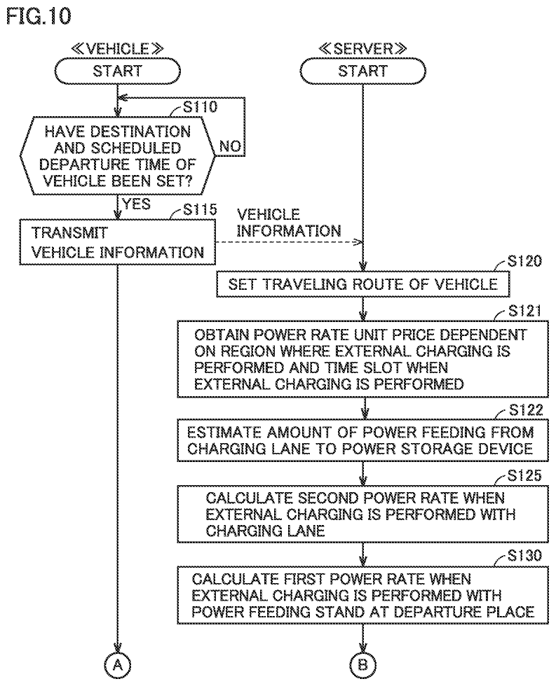

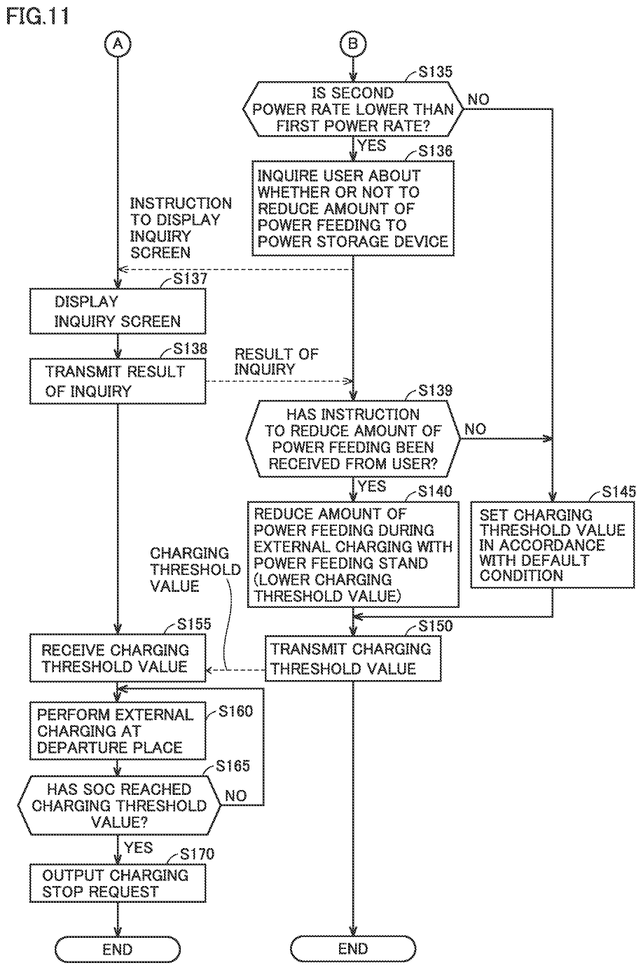

FIGS. 10 and 11 are a flowchart showing an example of a process performed in connection with the external charging of vehicle 100 in the second modification. This flowchart is started when ECU 160 receives, through CAN communication unit 174, the sensing signal indicating that the connector of power feeding stand 300 has been connected to inlet 150 of vehicle 100.

This flowchart is different from the flowchart in FIG. 8 in that the processing of steps S136 to S139 is added. The processing of steps S110 to S135 and S140 to S170 in the flowchart in FIGS. 10 and 11 is the same as the processing of steps S10 to S35 and S40 to S70 in the flowchart in FIG. 8, respectively.

Referring to FIG. 11, when the second power rate is lower than the first power rate (YES in step S135), processor 230 performs the process for inquiring user 195 about whether or not to reduce the amount of power feeding to power storage device 110 during the external charging with power feeding stand 300 at departure place P0 (step S136). Specifically, processor 230 transmits, to vehicle 100 through communication device 210, an instruction to cause display device 147 of HMI device 145 to display screen 600 (FIG. 9) for inquiry.

In response to the instruction, ECU 160 of vehicle 100 causes display device 147 to display screen 600 (step S137). Then, when button 610 or 615 is operated by user 195, ECU 160 transmits a signal indicating the result of operation (result of inquiry) to server 200 through communication device 170 (step S138).

In accordance with the signal indicating the result of inquiry, processor 230 of server 200 determines whether or not processor 230 of server 200 has received, from user 195, an instruction to reduce the amount of power feeding (step S139) Specifically, in accordance with the signal, processor 230 determines which of buttons 610 and 615 on screen 600 has been operated by user 195. When processor 230 has received, from user 195, the instruction to reduce the amount of power feeding (YES in step S139), processor 230 moves the process to step S140. Otherwise (NO in step S139), processor 230 moves the process to step S145.

As described above, in the second modification, processor 230 performs the process for inquiring user 195 of vehicle 100 about whether or not to reduce the amount of power feeding during the external charging with power feeding stand 300 at departure place P0. Thus, the convenience of user 195 can be improved.

[Third Modification]

Processor 230 may set a charging schedule of timer charging such that the first power rate unit price is lower when the timer charging is performed with power feeding stand 300 at departure place P0 than when the timer charging is not performed. The timer charging is the external charging that is performed in a time slot set in accordance with the charging schedule, and is automatically completed by the charging completion time earlier than the scheduled departure time of vehicle 100. The charging schedule set by processor 230 is transmitted to ECU 160.

As the first power rate unit price becomes lower, the first power rate becomes lower. Therefore, when the charging schedule is set as described above, the first power rate when the timer charging is performed with power feeding stand 300 at departure place P0 can be reduced. As a result, the total power rate (total of the first power rate and the second power rate) when the external charging is performed with power feeding stand 300 and charging lane 500 can be made lower than the total power rate when the timer charging is not performed. The following is a detailed description about this point.

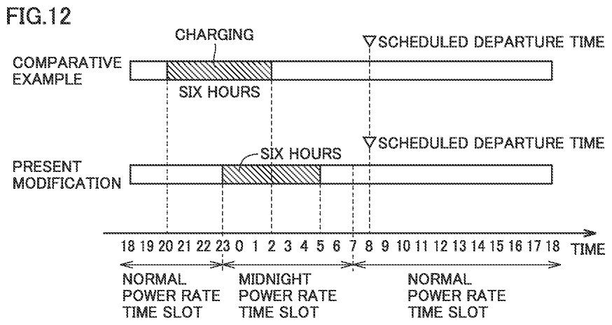

FIG. 12 shows an example of a time slot when the external charging is performed in a comparative example and a third modification. The comparative example will be described as an example of a case in which the charging schedule is not set by processor 230. In both of the comparative example and the third modification, the amount of electric power corresponding to PS1 (=PS−ΔPS) is supplied to power storage device 110 during the external charging at departure place P0.

Referring to FIG. 12, the scheduled departure time of vehicle 100 is 8 o'clock. In this example, a time period required for the external charging for supplying the amount of electric power corresponding to PS1 to power storage device 110 is six hours. The current time at which the connector of power feeding stand 300 is connected to inlet 150 at departure place P0 is 20 o'clock. The midnight time slot in which the power rate unit price is lower than that in the normal time slot is from 23 o'clock to 7 o'clock.

In the comparative example in which the timer charging is not performed, the external charging is performed over the six hours from 20 o'clock that is the current time to 2 o'clock. The first half (from 20 o'clock to 23 o'clock) of the time period in which the external charging is performed is included in the normal time slot, and the second half (from 23 o'clock to 2 o'clock) is included in the midnight time slot. Therefore, the half of the time period in which the external charging is performed is included in the normal time slot in which the power rate unit price is higher than that in the midnight time slot.

In contrast, in the third modification in which the timer charging is performed, the external charging is not started immediately at 20 o'clock that is the current time. Specifically, the charging schedule is set such that the external charging is performed over the six hours from 23 o'clock to 5 o'clock in the midnight time slot. As a result, the entire time period in which the external charging is performed is included in the midnight time slot in which the power rate unit price is lower than that in the normal time slot. Therefore, according to the third modification, the first power rate when the external charging is performed at departure place P0 can be made lower than the first power rate in the comparative example. As a result, the total power rate in the third modification can be made lower than the total power rate in the comparative example.

The start time of the timer charging is set by processor 230 such that the external charging is completed by the scheduled departure time (electric power corresponding to PS1 is supplied to power storage device 110) and the power rate unit price during the external charging is as low as possible. Processor 230 obtains, as the vehicle information through communication device 210, the presence or absence of the instruction to perform the timer charging, and a completion time of the timer charging in the presence of the instruction to perform the timer charging.

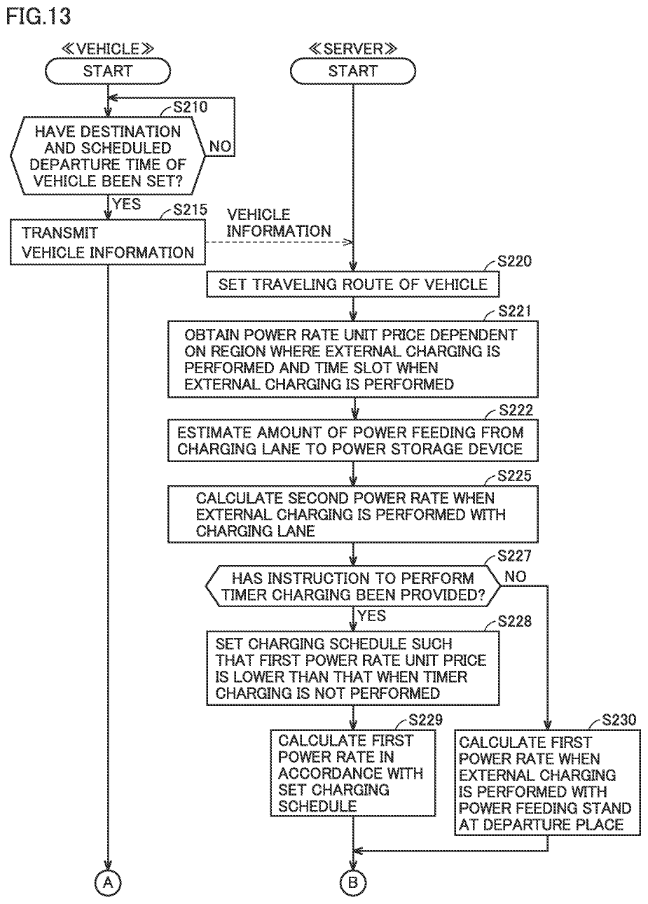

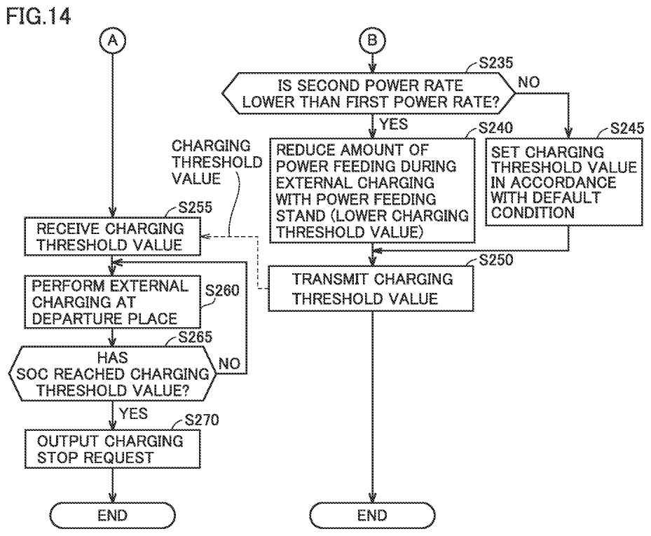

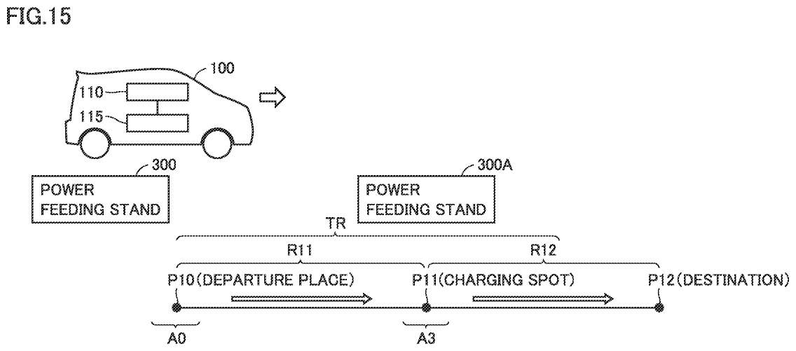

FIGS. 13 and 14 are a flowchart showing an example of a process performed in connection with the external charging of vehicle 100 in the third modification. This flowchart is started when ECU 160 receives, through CAN communication unit 174, the sensing signal indicating that the connector of power feeding stand 300 has been connected to inlet 150 of vehicle 100.

This flowchart is different from the flowchart in FIG. 8 in that the processing of steps S227 to S229 is added. The processing of steps S210 to S225 and S230 to S270 in the flowchart in FIGS. 13 and 14 is the same as the processing of steps S10 to S25 and S30 to S70 in the flowchart in FIG. 8, respectively.

Referring to FIG. 13, processor 230 determines whether or not the instruction to perform the timer charging has been provided, in accordance with the vehicle information (step S227). When the instruction to perform the timer charging has not been provided (NO in step S227), processor 230 calculates the first power rate in accordance with the first power rate unit price and the first amount of power feeding (step S230), similarly to step S30 in FIG. 8. In contrast, when the instruction to perform the timer charging has been provided (YES in step S227), processor 230 sets the charging schedule such that the first power rate unit price is lower than that when the timer charging is not performed (step S228). For example, processor 230 sets the charging start time and the charging end time of the timer charging such that the entire time period in which the external charging is performed at departure place P0 is included in the midnight time slot. The end time of the timer charging refers to a time at which the charging actually ends, and is different from the above-described charging completion time (time set by user 195 as the time at which the charging has already been completed).

Next, processor 230 calculates the first power rate that is dependent on the set charging schedule (step S229). For example, when the charging schedule is set such that the entire time period in which the external charging is performed at departure place P0 is included in the midnight time slot, a multiplied value of the time period in which the external charging is performed and the power rate unit price in the midnight time slot is calculated as the first power rate.

As described above, in the third modification, processor 230 sets the charging schedule of the timer charging such that the first power rate unit price is lower when the timer charging is performed with power feeding stand 300 at departure place P0 than when the timer charging is not performed.

Thus, the first power rate when the timer charging is performed with power feeding stand 300 at departure place P0 can be reduced. As a result, the total of the first power rate and the second power rate can be reduced.

[Fourth Modification]

In a fourth modification, processor 230 estimates an amount of charge power (amount of charge power during the wireless charging) charged from power transmission device 305 through power reception device 155 into power storage device 110, in accordance with the power transmission efficiency from power transmission device 305 of charging lane 500 to power reception device 155 of vehicle 100. Processor 230 determines the amount of reduction (amount of electric power corresponding to ΔPS in FIG. 7) in the amount of power feeding during the external charging with power feeding stand 300 such that the amount of reduction becomes smaller as the amount of charge power estimated as described above becomes smaller.

Specifically, processor 230 estimates the above-described amount of charge power by calculating a multiplied value of the amount of electric power transmitted from power transmission device 305 to power reception device 155 while vehicle 100 is travelling on charging lane 500 and the predicted value of the power transmission efficiency. As described above, the amount of electric power transmitted from power transmission device 305 to power reception device 155 is determined in accordance with the length of the time period in which power transmission device 305 transmits electric power to power reception device 155 and the transmission power of power transmission device 305. The above-described power transmission efficiency is stored in power feeding facility information DB 221 and data table 240 (FIG. 4). Processor 230 may estimate the amount of charge power charged into power storage device 110 during the wireless charging, in accordance with a power loss in an electric power path between the power reception device and power storage device 110 and the above-described multiplied value.

As the power transmission efficiency while vehicle 100 is traveling on charging lane 500 becomes lower, the amount of charge power charged from power transmission device 305 through power reception device 155 into power storage device 110 becomes smaller. Therefore, when the power transmission efficiency is low, the amount of reduction (amount of electric power corresponding to ΔPS) in the amount of power feeding during the external charging at departure place P0 may not be complemented by the transmission power of power transmission device 305 at charging lane 500, even if vehicle 100 travels on charging lane 500. As a result, it may be assumed that, due to the reduction in the amount of power feeding to power storage device 110 at departure place P0 by ΔPS, exhaustion of the amount of power storage in power storage device 110 occurs before vehicle 100 arrives at destination P3.

Thus, it is preferable that processor 230 should determine the amount of reduction (ΔPS) in the amount of power feeding during the external charging with power feeding stand 300 at departure place P0 such that ΔPS becomes smaller as the amount of charge power estimated as described above becomes smaller.

Thus, ΔPS is determined to appropriately reflect the power transmission efficiency while vehicle 100 is traveling on charging lane 500. Therefore, even when the power transmission efficiency in charging lane 500 is low, ΔPS decreases depending on the power transmission efficiency, and thus, an amount of lowering in the charging threshold value also decreases. As a result, exhaustion of the amount of power storage in power storage device 110 before vehicle 100 arrives at destination P3 can be avoided.

[Fifth Modification]

In the above-described embodiment and the first to fourth modifications thereof, charging lane 500 is used as an example of the second power feeding facility (power feeding facility 260 in FIG. 1) provided in the vicinity of traveling route TR from departure place P0 to destination P3 of vehicle 100.

In contrast, the second power feeding facility may be a power feeding stand at a charging spot (charging station). When the second power rate is lower than the first power rate, processor 230 reduces the amount of power feeding to power storage device 110 at departure place P0. With the amount of power feeding to power storage device 110 at departure place P0 reduced, vehicle 100 leaves departure place P0, and when vehicle 100 arrives at the charging spot, vehicle 100 stops. Then, vehicle 100 performs the external charging with the power feeding stand at the charging spot, as to the amount of electric power corresponding to the amount of reduction in the amount of power feeding at departure place P0.

Thus, even when charging lane 500 is congested, it is possible to reduce the above-described total power rate while avoiding the congestion.

FIG. 15 shows a traveling route of vehicle 100 in a fifth modification. Traveling route TR1 includes a route R11 and a route R12.

Route R11 is a route of vehicle 100 from a departure place P10 to a point P11. Point P11 corresponds to the charging spot. Point P11 is located in a region A3 (FIG. 4). Route R12 is a route of vehicle 100 from point P11 to a point P12.

In this example, power feeding stand 300 (first power feeding facility) is provided at departure place P0. A power feeding stand 300A (second power feeding facility) is provided at point P11. A wireless charging facility may be used instead of each of power feeding stands 300 and 300A.

The second power rate is calculated by processor 230 in accordance with a power rate unit price when the external charging is performed with power feeding stand 300A. This power rate unit price is dependent on region A3 where power feeding stand 300A is provided, and a time slot including a time at which vehicle 100 is expected to arrive at power feeding stand 300A along traveling route TR, and this power rate unit price is obtained from power feeding facility information DB 221 (FIGS. 3 and 4) by communication device 210. This time slot is estimated by processor 230 in accordance with a distance from departure place P10 to point P11, the expected traveling speed of vehicle 100, and the scheduled departure time of vehicle 100. The expected traveling speed of vehicle 100 refers to, for example, an average speed of a legal upper limit speed and a legal lower limit speed of vehicle 100 on route R11.

Processor 230 compares the second power rate with the first power rate, assuming that the first amount of power feeding is equal to the second amount of power feeding. The subsequent process is the same as the process described in the foregoing embodiment.

[Sixth Modification]

In the above-described embodiment and the first to fifth modifications thereof, server 200 is used as an example of “controller for a vehicle” according to the present disclosure. However, ECU 160 of vehicle 100 or user terminal 400 may be used as an example of “controller for a vehicle”.

When ECU 160 is used as “controller for a vehicle”, CPU 161 forms an example of “processor” according to the present disclosure, and input/output interface 163 forms an example of “obtaining device” according to the present disclosure.

When user terminal 400 is used as “controller for a vehicle”, processor 410 forms an example of “processor” according to the present disclosure, and communication device 430 forms an example of “obtaining device” according to the present disclosure.

[Seventh Modification]

In the above-described embodiment and the first to sixth modifications thereof, vehicle 100 is a BEV. However, the vehicle is not limited to a BEV, and may be an electrically powered vehicle such as a plugin hybrid electric vehicle (PHEV) further including an internal combustion engine. In this case, the vehicle may be capable of traveling using only the electric power of power storage device 110 while the internal combustion engine is not operating (so-called EV mode of the vehicle may be possible). During the EV mode of the vehicle, the above-described embodiment and the first to sixth modifications thereof may be applied as they are.

In contrast, when the vehicle travels while the internal combustion engine is driven, processor 230 may determine ΔPS (FIG. 7) based on the electric power generated by MG 130 during traveling of vehicle 100 and the amount of power feeding from power transmission device 305 (second power feeding facility) at charging lane 500 to power storage device 110.

[Other Modification]

In the above-described embodiment and the first to seventh modifications thereof, the midnight time slot is used as an example of the time slot in which the power rate unit price is lower than those in the other time slots. However, the present disclosure is not limited to the foregoing. For example, when the electric power supplied to the power grid increases due to power generation by a solar cell in the daytime time slot in the summer, the power rate unit price may become lower than that in the midnight time slot. In this case, the normal time slot including the daytime time slot may be used as the time slot in which the power rate unit price is lower than that in the midnight time slot.

The power feeding facility provided at home of user 195 is used as an example of the first power feeding facility provided at departure place P0. However, the present disclosure is not limited to the foregoing. For example, when a power feeding facility is provided outside the home and user 195 goes home from outside the home, the power feeding facility provided outside the home corresponds to the first power feeding facility.

Although the embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A controller for a vehicle, the vehicle being capable of performing external charging to charge a power storage device mounted on the vehicle with a power feeding facility provided outside the vehicle, the controller comprising:
an obtaining device that obtains a power rate unit price, the power rate unit price being dependent on a region where the external charging is performed and a time slot when the external charging is performed; and
a processor that calculates a power rate when the external charging is performed, in accordance with an amount of power feeding to the power storage device by the external charging, the region where the external charging is performed and the time slot when the external charging is performed, and the power rate unit price obtained by the obtaining device, wherein
under a condition that a traveling route from a departure place to a destination of the vehicle and a scheduled departure time of the vehicle are set,
the processor
calculates a first power rate, the first power rate indicating a power rate when the external charging is performed with a first power feeding facility provided at the departure place before departure of the vehicle,
calculates a second power rate, the second power rate indicating a power rate when the external charging is performed with a second power feeding facility provided in the vicinity of the traveling route after departure of the vehicle, and
when the second power rate is lower than the first power rate, reduces the amount of power feeding during the external charging with the first power feeding facility, as compared with when the second power rate is equal to or higher than the first power rate.

2. The controller for the vehicle according to claim 1, wherein
the vehicle includes a power reception device that wirelessly receives electric power from a power transmission device while the vehicle is traveling on a traveling lane, the power transmission device being placed at the traveling lane and serving as the second power feeding facility,
the vehicle performs the external charging such that the electric power received by the power reception device is stored in the power storage device, and
the processor calculates the second power rate as a power rate when the external charging is performed while the vehicle is traveling on the traveling lane.

3. The controller for the vehicle according to claim 2, wherein
the processor
estimates an amount of charge power charged into the power storage device from the power transmission device through the power reception device, in accordance with a power transmission efficiency from the power transmission device to the power reception device, and
determines an amount of reduction in the amount of power feeding during the external charging with the first power feeding facility such that the amount of reduction is smaller as the estimated amount of charge power is smaller.

4. A controller for a vehicle, the vehicle being capable of performing external charging to charge a power storage device mounted on the vehicle with a power feeding facility provided outside the vehicle, the controller comprising:
an obtaining device that obtains a power rate unit price, the power rate unit price being dependent on a region where the external charging is performed and a time slot when the external charging is performed; and
a processor, wherein
under a condition that a traveling route from a departure place to a destination of the vehicle and a scheduled departure time of the vehicle are set,
the processor
obtains a first power rate unit price through the obtaining device, the first power rate unit price indicating a power rate unit price when the external charging is performed with a first power feeding facility provided at the departure place before departure of the vehicle,
obtains a second power rate unit price through the obtaining device, the second power rate unit price indicating a power rate unit price when the external charging is performed with a second power feeding facility provided in the vicinity of the traveling route after departure of the vehicle, and
when the second power rate unit price is lower than the first power rate unit price, reduces an amount of power feeding to the power storage device during the external charging with the first power feeding facility, as compared with when the second power rate unit price is equal to or higher than the first power rate unit price.

5. The controller for the vehicle according to claim 4, wherein
the processor sets a charging schedule such that the first power rate unit price is lower when timer charging is performed in a time slot set in accordance with the charging schedule than when the timer charging is not performed, the timer charging being the external charging with the first power feeding facility.

6. The controller for the vehicle according to claim 1, wherein
the processor performs a process for inquiring a user of the vehicle about whether or not to reduce the amount of power feeding.

7. A charging system comprising:
a vehicle, the vehicle being capable of performing external charging to charge a power storage device mounted on the vehicle with a power feeding facility provided outside the vehicle, the vehicle stopping the external charging when an SOC of the power storage device reaches a threshold value; and
a server, wherein
the server includes:
an obtaining device that obtains a power rate unit price, the power rate unit price being dependent on a region where the external charging is performed and a time slot when the external charging is performed; and
a processor that calculates a power rate when the external charging is performed, in accordance with an amount of power feeding to the power storage device by the external charging, the region where the external charging is performed and the time slot when the external charging is performed, and the power rate unit price obtained by the obtaining device,
under a condition that a traveling route from a departure place to a destination of the vehicle and a scheduled departure time of the vehicle are set,
the processor
calculates a first power rate, the first power rate indicating a power rate when the external charging is performed with a first power feeding facility provided at the departure place before departure of the vehicle,
calculates a second power rate, the second power rate indicating a power rate when the external charging is performed with a second power feeding facility provided in the vicinity of the traveling route after departure of the vehicle, and
when the second power rate is lower than the first power rate, lowers the threshold value such that the amount of power feeding during the external charging with the first power feeding facility is reduced, as compared with when the second power rate is equal to or higher than the first power rate, and
the vehicle performs the external charging with the first power feeding facility in accordance with the lowered threshold value.
